(19) United States
(12) Patent Application Publication
(10) Pub. No.: US 2012/0220342 A1
(43) Pub. Date: Aug. 30, 2012

(54) Luminous cellphone display

(76) Inventor: Thomas R. Holliday, Lyons, IL (US)

(21) Appl. No.: 13/385,502

(22) Filed: Feb. 21, 2012

Related U.S. Application Data
(60) Provisional application No. 61/463,564, filed on Feb. 18, 2011.

(51) Int. Cl. H04W 88/02

(52) U.S. Cl. 455/566

(57) ABSTRACT

Embodiments of the invention relate to a method and device for detecting cellular device use and letting an immediately surrounding public that the cellular device is in use by lighting and displaying an indicia. One embodiment relates to a device for indicating use of a cellular device. The device includes a detecting circuit receiving an input and terminating in light generation; and at least one lens receiving and displaying the light indicating to an immediate surrounding public that the cellular device is in use.

### CLAIM FOR PRIORITY

This application claims priority from U.S. Provisional Application Ser. No. 61/463,564 filed Feb. 18, 2011, the complete subject matter of which is incorporated herein by reference in its entirety.

### FIELD OF THE INVENTION

The invention relates to cellular device use. More specifically, embodiments relate to a method and device for detecting cellular device use and indicating such cellular device use.

### BACKGROUND OF THE INVENTION

Headsets are used in variety of applications to facilitate one- or two-way audio communications between users and/or devices. For example, many aircraft pilots wear headsets to enable them to communicate via two-way radio with other aircraft and air-traffic controllers as well as via a public-address system with passengers. Additionally, headsets are worn to facilitate hands-free usage of mobile telephones, while others facilitate private listening to devices, such as computers, stereos, disk players, etc.

One problem with conventional headsets, such as in-the-ear headsets and ANR headsets, is that, the smaller such devices become, other people don't recognize that the headset is in use and the user is busy. Accordingly, there is a need for methods and devices that indicate such headsets are in use and that the user is busy.

For the foregoing reasons, there is a need for a method and device that detects cellular device use. More specifically, embodiments relate to a method and device for detecting cellular device use and indicating such use.

### SUMMARY OF THE INVENTION

One embodiment relates to detecting cellular device use and indicating such use. One or more embodiments relates to a device for indicating use of a cellular device. The device includes a detecting circuit receiving an input and terminates in light generation; and at least one lens receiving and displaying the light indicating to an immediate surrounding public that the cellular device is in use.

Still other embodiments relate to a device for indicating to an immediate surrounding public that a cellular device is in use. The device includes a housing comprising a chamber and defining at least one hole; a detecting circuit having at least one microprocessor for generating at least one electrical signal, the detecting circuit positioned in the chamber; at least one light source in communication with the detecting circuit receiving the at least one electrical signal and generating light in response to the received electrical signal; and at least one lens having indicia thereon coupled to the housing, receiving and displaying the light indicating that the cellular device is in use.

Yet other embodiments relate to a method for indicating use to a immediately surrounding public of a cellular device. The method includes detecting that the cellular device is in use; generating an electric signal responsive to such use detection; and generating an indication signal including indicia that the cellular device is in use responsive to the generated electrical signal.

One or more embodiments relate to light generation further comprises a light positioned in a hole in the device, where the hole is adapted to have at least one lens positioned therein. The at least one lens (with or without indicia) may be fixed in the hole or removable positioned in the hole.

More specifically, one embodiment relates to a method for indicating use of a cellular device, including detecting that the cellular device is in use and generating an electric signal responsive to such use detection. An indication signal is generated indicating that the cellular device is in use responsive to the generated electrical signal.

Another embodiment relates to a device for indicating use of a cellular device. The device includes a circuit for detecting that the cellular device is in use and generating an electrical signal responsive to detecting such use; and an indicator device for generating an indication signal responsive to the generated electrical signal.

Still another embodiment relates to an in-the-ear headset including at least one in-the-ear audio transducer for insertion into a user's ear; a boom microphone in generally fixed relation to the at least one transducer; a circuit for detecting that the headset is in use and generating an electrical signal responsive to such use detection; and an indicator device for generating an indication signal responsive to the generated electrical signal.

Yet another embodiment relates to a cellular device including at least one audio transducer; a microphone in generally fixed relation to the at least one audio transducer; a circuit for detecting that the cellular device is in use and generating an electrical signal responsive to detecting such use; and an indicator device for generating an indication signal responsive to the generated electrical signal.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a top plan view of a headset in accordance with one embodiment;

FIG. 2 is a side perspective view of the headset of FIG. 1 in accordance with one embodiment; and

FIG. 3 is a circuit diagram of a detecting circuit used with the headset of FIG. 1-2 in accordance with one embodiment.

Throughout the various figures, like reference numbers refer to like elements.

### DETAILED DESCRIPTION OF PRESENTLY PREFERRED EMBODIMENTS

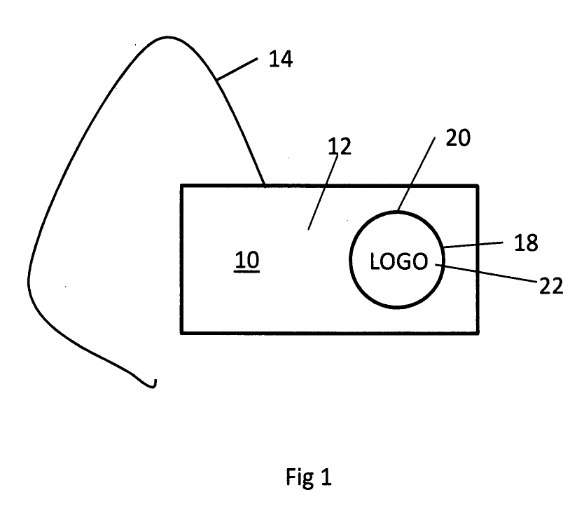

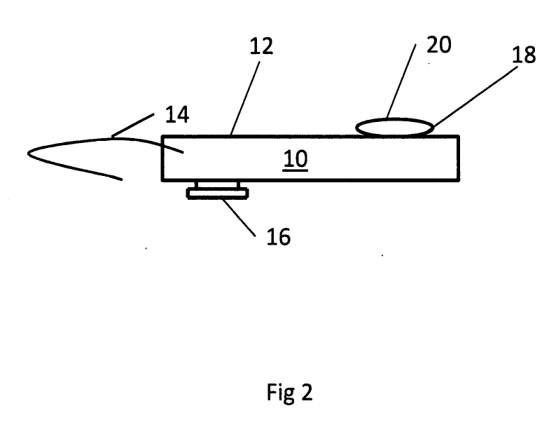

FIGS. 1 and 2 depict a headset, generally designated 10, used with a cellular device for example. The headset 10 includes a housing 12 and securing device 14 for securing the headset 10 to a user's head (by hooking around an ear for example). The headset 10 includes an earpiece 16 having a first end in communication with the headset 10 and a second end adapted to be inserted, at least part way, into the user's ear (best viewed in FIG. 2) and a boom microphone (not shown).

In at least one embodiment, the housing 12 defines at least one hole or opening 18 in communication with an interior space or chamber defined by the housing 12. The interior space contains a module, processor or codec, enabling headset 10 to wirelessly communicate with another device (a cell phone for example) via short range radio technology (Bluetooth technology). In at least one embodiment, the module, processor or codec wirelessly receives electric signals and converts the electric signals to sound transmitted to the user via an earpiece 16.

In at least one embodiment, the headset 10 includes a lens or plate 20 connected or in communication with the hole 18. Lens 20 may be clear or opaque, and may be fixedly or removably connected to the housing 12 and/or hole 18. In one or more embodiments, lens 20 includes indicia 22, where indicia 22 may include a logo, trademark, figure, symbol, design, jewelry and the like. The lens 20 may be formed of glass, plastic, or hard resin, with the indicia 22 tinted, silkscreened or otherwise printed on the lens 20. Alternatively, the indicia 22 may be printed on a clear sheet that is adhered to the lens 20.

In one or more embodiments, the housing 12 may include an attachment device for removably attaching the housing 12 to a user's clothing and/or a removable face plate. In one or more embodiments, the face plate may be from the group including transparent, opaque or semi-opaque plates and may be personalized using indica, color, design, jewelry, and the like.

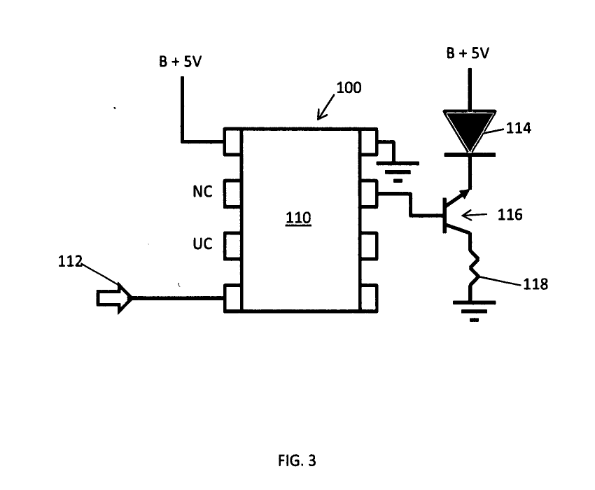

FIG. 3 depicts a circuit diagram of a detecting circuit, generally 100, used with the headset 10 of FIG. 1-2 in accordance with one embodiment. The detecting circuit 100 includes a microprocessor 110 (a PIC12F683 microprocessor for example) in electrical communication with module, processor or codec, and LED 114, transistor 116 (a 2N2222 transistor for example) and resistor 118 (220 ohm resistor for example), where light generated by the LED 114 is produced through the hole 18 and lens 20. It should be appreciated that, while a LED 114 is discussed, any light source, including bulbs and fiber optic cables, and the like are contemplated.

In at least one embodiment, the microprocessor 110 receives an input 112 from the module, processor or codec when the module, processor or codec detects cellular use of is otherwise communicating with the other cellular device. In one embodiment the module, processor or codec detects cellular device use including detecting one or more incoming phone calls, outgoing phone calls, incoming text messages, outgoing text messages, internet access and combinations thereof. The module, processor or codec generates a signal that is received as the input 112 to the detecting circuit 100. The microprocessor 110 receives the input 112, in turn lighting LED 114 in response to such input 112. In one or more embodiments, different electrical signals are generated responsive to detecting the incoming phone call, the outgoing phone call, the incoming text message, the outgoing text message and the internet access. Different indication signals are generated responsive to the different electrical signals.

One embodiment relates to detecting cellular device use and indicating such use. More specifically, one embodiment relates to a method for indicating use of a cellular device, including detecting that the cellular device is in use and generating an electric signal responsive to such use detection. An indication signal is generated indicating that the cellular device is in use responsive to the generated electrical signal.

One embodiment of the method of detecting cellular device use includes detecting one or more incoming phone calls, outgoing phone calls, incoming text messages, outgoing text messages, internet access and combinations thereof. A different electrical signal is generated responsive to detecting the incoming phone call, the outgoing phone call, the incoming text message, the outgoing text message and the interne access. Different indication signals are generated responsive to the different electrical signals.

In one or more embodiments the indication signal is an audio indication signal, a visual indication signal or both. The method terminates the indication signal when the cellular device is no longer in use.

In one or more embodiments, the detecting circuit 100 detects one or more incoming phone calls, outgoing phone calls, incoming text messages, outgoing text messages, internet access or combinations thereof. The detecting circuit 100 generates different electrical signals responsive to detecting the incoming phone calls, the outgoing phone calls, the incoming text messages, the outgoing text messages and internet access. Different indication signals are generated responsive to the different electrical signals.

In one or more embodiments the indication signal is an audio indication signal, a visual indication signal or combinations thereof. The indication device is at least one light source, a plurality of light sources or a plurality of different colored light sources, where the different light sources indicate different status of the cellular device. In at least one embodiment, the light source is selected from the group including LEDs, bulbs, fiber optic cables and the like. Furthermore, the light source may flash or pulse at set or varying rates, either undercontrol of the microprocesser or the bypass circuit. Furthermore it may flash in one or different colors.

Still one or more embodiments include an override circuit (not shown) coupled to at least one of the detecting circuit 100 and the headset 10. The override circuit enables a user to engage and/or disengage the indicator device at their discretion. This embodiment may include a switch coupled to the override circuit, whereby the user may engage/disengage the override circuit.

Still another embodiment relates to an in-the-ear headset comprising at least one in-the-ear audio transducer for insertion into a user's ear; a boom microphone in generally fixed relation to the at least one transducer; a circuit for detecting that the headset is in use and generating an electrical signal responsive to such use detection; and an indicator device for generating an indication signal responsive to the generated electrical signal.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A device for indicating use of a cellular device, the device comprising:
a detecting circuit receiving an input and terminating in light generation; and
at least one lens receiving and displaying the light indicating to an immediate surrounding public that the cellular device is in use.

2. The device of claim 1 wherein the light generation further comprises a light positioned in a hole in the device.

3. The device of claim 2 wherein the hole is adapted to have at least one lens positioned therein.

4. The device of claim 3 wherein the at least one lens is fixed in the hole.

5. The device of claim 3 wherein the at least one lens being removable positioned in the hole.

6. The device of claim 3 wherein the at least one lens with at least one indicia is fixed in the hole.

7. The device of claim 3 wherein the at least one lens with at least one indicia being removable positioned in the hole.

8. The device of claim 1 wherein the detecting circuit detects an incoming phone call, an outgoing phone call, an incoming text message, an outgoing text message and an internet access.

9. The device of claim 8 wherein the detecting circuit generates a different electrical signal responsive to detecting the incoming phone call, the outgoing phone call, the incoming text message, the outgoing text message and the internet access.

10. The device of claim 1 further including at least one light source communicating with the detecting circuit generating the light.

11. The device of claim 10, wherein the at least one light source is selected from the group comprising LEDs, bulbs and fiber optics.

12. A device for indicating to an immediate surrounding public that a cellular device is in use, the device comprising:
a housing comprising a chamber and defining at least one hole;
a detecting circuit having at least one microprocessor for generating at least one electrical signal, the detecting circuit positioned in the chamber;
at least one light source in communication with the detecting circuit receiving the at least one electrical signal and generating light in response to the received electrical signal;
at least one lens having indicia thereon coupled to the housing, receiving and displaying the light indicating that the cellular device is in use.

13. The device of claim 12 wherein the at least one lens is fixed in the hole.

14. The device of claim 12 wherein the at least one lens being removable positioned in the hole.

15. The device of claim 12 wherein the detecting circuit detects an incoming phone call, an outgoing phone call, an incoming text message, an outgoing text message and an interne access.

16. The device of claim 15 wherein the detecting circuit generates a different electrical signal responsive to detecting the incoming phone call, the outgoing phone call, the incoming text message, the outgoing text message and the internet access.

17. The device of claim 12, wherein the at least one light source is selected from the group comprising LEDs, bulbs and fiber optics.

18. A method for indicating use to a immediately surrounding public of a cellular device, the method comprising:
detecting that the cellular device is in use;
generating an electric signal responsive to such use detection; and
generating an indication signal including indicia that the cellular device is in use responsive to the generated electrical signal.

19. The method of claim 18 wherein detecting the cellular device is in use includes detecting an incoming phone call, an outgoing phone call, an incoming text message, an outgoing text message and interne access.

20. The method of claim 18 wherein the indicia is selected from the group comprising a logo, trademark, figure, symbol, and a design.
